(19) United States
(12) Patent Application Publication
(10) Pub. No.: US 2013/0242186 A1
(43) Pub. Date: Sep. 19, 2013

(54) IMAGE PROCESSING APPARATUS AND CONTROL METHOD THEREOF

(71) Applicant: SAMSUNG ELECTRONICS CO., LTD., Suwon-si (KR)

(72) Inventor: Chunbo ZHU, Nanjing (CN)

(73) Assignee: SAMSUNG ELECTRONICS CO., LTD., Suwon-si (KR)

(21) Appl. No.: 13/828,157

(22) Filed: Mar. 14, 2013

(30) Foreign Application Priority Data
Mar. 14, 2012 (CN) 201210066502.5
Feb. 28, 2013 (KR) 10-2013-0022301

(51) Int. Cl. H04N 7/01

(52) U.S. Cl. CPC H04N 7/0127
USPC 348/441

(57) ABSTRACT

Provided are an image processing apparatus and a control method thereof for optimizing a played image. The image processing apparatus includes: an image receiver which receives an input image; an image processor which processes the input image to output an output image; a display which displays the output image; a storage which stores data and information about the input image; and a controller which compares an image processing speed of the input image with a frame rate of the input image, sets a frame rate of the output image to be less than the frame rate of the input image when the frame rate of the input image is greater than the image processing speed of the input image, and reduces a number of frames of the input image to be image-processed based on the set frame rate.

### CROSS-REFERENCE TO RELATED APPLICATIONS

This application claims priorities from Chinese Patent Application No. 201210066502.5, filed on Mar. 14, 2012 in the State Intellectual Property Office and Korean Patent Application No. 10-2013-0022301, filed on Feb. 28, 2013 in the Korean Intellectual Property Office, the disclosures of which are incorporated herein by reference in their entireties.

### BACKGROUND

1. Field

Aspects of exemplary embodiments relate to a method of playing an image of an image processing apparatus, and more particularly, to a method for optimizing an image of an image processing apparatus.

2. Description of the Related Art

A related art image processing apparatus, which is based on an embedded device or a platform, may provide two different choices for a user, that is, video hardware decoding/displaying or video software decoding/displaying. When the user selects an option of hardware decoding/displaying, a related art image processing apparatus may employ a platform-related interface to perform hardware decoding and displaying, and the implementation thereof may be supplied by each hardware provider. When the user selects an option of software decoding/displaying, a related art image processing apparatus may employ a software decoder to execute video decoding, and use a software displaying interface to display.

The modules in a related art image processing apparatus, which is based on an embedded or predetermined platform, are independent of a hardware system. The above related art multimedia software player may be implemented and controlled with a multi-threaded software. Since a Central Processing Unit (CPU) occupation rate and a system resources usage rate thereof are higher, decoding speed thereof is lower, and a software scheme may not fluently (e.g., fluidly) play Standard Definition (SD) videos, High Definition (HD) videos, and videos with 720p resolution, such as Moving Pictures Experts Group-4 (MPEG-4), H.264, etc. When employing the hardware decoding scheme, since bottom interfaces and implementations of various hardware may be different, a universal property and portability of the hardware decoding scheme may be lower. Furthermore, support of the hardware decoder for video formats (such as MPEG4, H.264, etc.), profile, level, and resolution is limited, which may have different performances on different hardware devices. The above problem of the hardware decoding scheme may be solved by employing a general software decoding scheme. However, performance of the general software decoding scheme may be limited to a large extent.

In view of the above, the related art puts forward some optimized schemes. Optimizations for a related art image processing apparatus mainly focus on optimization for decoding, optimization for reducing memory operations, executing algorithm optimization, or dedicated hardware optimization for each module in a video decoder, such as Inverse Discrete Cosine Transform (IDCT), inverse quantization, entropy decoding, motion compensation, loop filter, reducing resolution and decoding, converting color, image scaling, etc. However, an optimization universal property is lower, and an optimization degree is limited.

### SUMMARY

One or more exemplary embodiments provide an image processing apparatus and a control method thereof for optimizing a played image, so as to improve fluency of video playing and to reduce occupation rates of a CPU and system resources.

According to an aspect of an exemplary embodiment, there is provided an image processing apparatus including: an image receiver which receives an input image; an image processor which processes the input image to output an output image; a display which displays the output image; a storage which stores data and information about the input image; and a controller which compares an image processing speed of the input image with a frame rate of the input image, sets a frame rate of the output image to be less than the frame rate of the input image when the frame rate of the input image is greater than the image processing speed of the input image, and reduces a number of frames of the input image to be image-processed based on the set frame rate.

The controller may calculate a real-time reduction rate of frames of the input image based on the image processing speed of the input image and the frame rate of the output image and implement down-sampling of the frames of the input image based on the calculated real-time reduction rate.

The controller may select predetermined frames of the input image for which reduction of number of frames to be subject to image processing is executed according to a frame priority and a structure of Group of Pictures (GOP) via down-sampling and discard the selected predetermined frames without image processing.

The controller may calculate a reduction rate of frames of the output image based on the frame rate of the output image and the frame rate of the input image, discard the predetermined frames evenly based on the reduction rate of frames of the output image when discarding the predetermined frames, and discard all frames for which reduction of number of frames to be subject to image processing is executed when number of frames for which reduction of the number of frames to be subject to image processing is executed is smaller than number of the predetermined frames of the input image by the reduction rate of frames of the output image.

The controller may calculate the real-time reduction rate of frames of the input image based on the image processing speed and the frame rate of the output image, select the predetermined frames of the input image for executing frame reduction so as to output an image based on the calculated real-time reduction rate, and image-process the predetermined frames without image outputting when number of frames for which reduction of number of frames to be subject to image processing is executed is smaller than number of the predetermined frames of the input image by the reduction rate of frames of the output image.

The controller may calculate a ratio between the image processing speed of one frame of the input image in each GOP and an average image processing speed of a frame of the input image, determine a real-time reduction rate in the GOP by multiplying the calculated ratio by the reduction rate of frames of the output image by frame reduction so as to output an image, and evenly execute frame reduction so as to output an image using the real-time reduction rate in the GOP.

The image processor may further include a converter which converts a YCbCr format into an RGB format, and the controller may reduce a calculation amount in conversion by converting the input image including a predetermined conversion calculation when converting the input image from the YCbCr format into the RGB format.

The controller may execute fixed-point processing, removal multiplication, multi-point simultaneous calculation, table querying, removal addition, and amplitude limiting calculation by enabling the predetermined conversion calculation to include shift, table querying, logic operation and a small quantity of additions.

The image processing apparatus may further include a user inputter which receives an input with respect to an image signal, wherein the controller may reduce resolution of the output image using an every-point calculation based on size of a displaying area of the display when an input with respect to firstly fluently playing is made from the user inputter.

The image processor may further include a decoder which decodes the input image, and the controller may dispose the converter and the decoder in series and implement parallel operations of conversion from the YCbCr format to the RGB format and image processing of the input image.

The controller may reduce the resolution with a proportion of ½ to 1/16.

The storage may further include an output image storage which stores the output image, and the controller may compare resolution of the output image processed by the image processor with a size of a displaying area of the display and display the output image and the input image based on a comparison result or display an image by scaling the output image.

The controller may enlarge the output image using a bilinear interpolation, maintaining a width to height ratio of the input image when the resolution of the output image is smaller than ½ the size of the displaying area of the display, and the controller may dispose at least one side of a width side and a height side of the output image in a central position of a corresponding side on the displaying area of the display when the other side corresponds to the displaying area of the display.

The controller may display at least one of the output image and the input image to be disposed in a central position of the displaying area of the display when the resolution of the output image is smaller than a predetermined range of the size of the displaying area of the display.

The controller may narrow the output image using a nearest neighbor method, maintaining a width to height ratio of the input image when the resolution of the output image is larger than a predetermined range of the size of the displaying area of the display, and the controller may dispose at least one of a width side and a height side of the output image in a central position of the corresponding side on the displaying area of the display when the other side corresponds to the displaying area of the display.

The controller may implement fixed-point processing for coordinate calculation so as to optimize the nearest neighbor method and the bilinear interpolation, establish a table for coordinates for conversion when calculating a frame, calculate coordinates of frames by table querying and simple addition operation, without calculation, and process RGB colors of a pixel simultaneously by the nearest neighbor method.

According to an aspect of another exemplary embodiment, the is provided a control method of an image processing apparatus, the method including: receiving an input image; comparing an image processing speed of the input image with a frame rate of the input image; setting a frame rate of an output image to be less than the frame rate of the input image when the frame rate of the input image is greater than the image processing speed of the input image; and reducing a number of frames of the input image to be image-processed based on the set frame rate.

The reducing the number of frames may include calculating a real-time reduction rate of frames of the input image based on the image processing speed of the input image and the frame rate of the output image and implementing down-sampling of the frames of the input image based on the calculated real-time reduction rate.

The implementing the down-sampling may include selecting predetermined frames of the input image for which reduction of number of frames to be subject to image processing is executed according to a frame priority and a structure of Group of Pictures (GOP) via down-sampling and discarding the selected predetermined frames without image processing.

The discarding without the image processing may include calculating a reduction rate of frames of the output image based on the frame rate of the output image and the frame rate of the input image, discarding the predetermined frames evenly based on the reduction rate of frames of the output image, and discarding all frames for which reduction of number of frames to be subject to image processing is executed when number of frames for which reduction of the number of frames to be subject to image processing is executed is smaller than number of the predetermined frames of the input image by the reduction rate of frames of the output image.

The discarding without the image processing may further include calculating the real-time reduction rate of frames of the input image based on the image processing speed and the frame rate of the output image, selecting the predetermined frames of the input image for executing frame reduction so as to output an image based on the calculated real-time reduction rate, and image-processing the predetermined frames without image outputting when number of frames for which reduction of number of frames to be subject to image processing is executed is smaller than number of the predetermined frames of the input image by the reduction rate of frames of the output image.

The discarding all the frames may further include calculating a ratio between the image processing speed of one frame of the input image in each GOP and an average image processing speed of a frame of the input image, determining a real-time reduction rate in the GOP by multiplying the calculated ratio by the reduction rate of frames of the output image by frame reduction so as to output an image, and evenly executing frame reduction so as to output an image using the real-time reduction rate in the GOP.

The reducing the number of frames may further include reducing a calculation amount in conversion by converting the input image including a predetermined conversion calculation when converting the input image from a YCbCr format into an RGB format.

The predetermined conversion calculation is enabled to include shift, table querying, logic operation and a small quantity of additions to execute fixed-point processing, removal multiplication, multi-point simultaneous calculation, table querying, removal addition, and amplitude limiting calculation.

The reducing the calculation amount may include reducing resolution of the output image using an every-point calculation based on size of a displaying area in which an image is displayed when an input with respect to firstly fluently playing is made by a user.

The reducing the calculation amount may include implementing parallel operations of conversion from a YCbCr format to an RGB format and image processing of the input image by disposing a conversion unit converting the YCbCr format to the RGB format and a decoding unit image-processing the input image in series.

The reducing the resolution may include reducing the resolution with a proportion of ½ to 1/16.

The reducing the number of frames may further include comparing resolution of the output image with size of a displaying area on which the output image is displayed and displaying the output image and the input image based on a comparison result or displaying an image by scaling the output image.

The displaying the image may include enlarging the output image using a bilinear interpolation, maintaining a width to height ratio of the input image when the resolution of the output image is smaller than ½ the size of the displaying area on which the output image is displayed, and disposing at least one side of a width side and a height side of the output image in a central position of a corresponding side on the displaying area on which the output image is displayed when the other side corresponds to the displaying area on which the output image is displayed.

The displaying the image may include displaying at least one of the output image and the input image to be disposed in a central position of the displaying area on which the output image is displayed when the resolution of the output image is smaller than a predetermined range of the size of the displaying area on which the output image is displayed.

The displaying the image may include narrowing the output image using a nearest neighbor method, maintaining a width to height ratio of the input image when the resolution of the output image is larger than a predetermined range of the size of the displaying area on which the output image is displayed, and disposing at least one of a width side and a height side of the output image in a central position of the corresponding side on the displaying area on which the output image is displayed when the other side corresponds to the displaying area on which the output image is displayed.

The control method may include implementing fixed-point processing for coordinate calculation so as to optimize the nearest neighbor method and the bilinear interpolation, establishing a table for coordinates for conversion when calculating a frame, calculating coordinates of frames by table querying and simple addition operation, without calculation, and processing RGB colors of a pixel simultaneously by the nearest neighbor method.

According to an aspect of another exemplary embodiment, there is provided an image processing apparatus including: an image processor which processes an input image to output an output image; and a controller which compares an image processing speed of the input image with a frame rate of the input image, sets a frame rate of the output image to be less than the frame rate of the input image when the frame rate of the input image is greater than the image processing speed of the input image, and reduces a number of frames of the input image to be image-processed based on the set frame rate.

As described above, according to one or more exemplary embodiments, there are provided an image forming apparatus and a control method thereof which are achieved by use of software separate from hardware, have a universal property, and support various types of video formats.

Further, video decoding, color change, image scaling, decoding speed control, video frame display, use of a system memory, and frame buffering may be combined optimally, thereby obtaining a universal property for improving fluency of video playing. Further, occupancy rates of Central Processing Unit (CPU) and system resources may be effectively reduced.

### BRIEF DESCRIPTION OF THE DRAWINGS

The above and other aspects, features and other advantages will be more clearly understood from the following detailed description taken in conjunction with the accompanying drawings, in which:

FIG. 1 is a schematic diagram illustrating a framework of software of an image processing apparatus, which is based on a platform according to an exemplary embodiment;

FIG. 2 is a schematic diagram illustrating a logic constitution of software of the image processing apparatus in FIG. 1;

FIG. 3 is a schematic diagram illustrating a length and a value of each interval in an amplitude limitation table, when employing an RGB rapid conversion method of an image processing apparatus according to an exemplary embodiment;

FIG. 4 is a schematic diagram illustrating a processing of four brightness pixels and two chromatic aberration components, simultaneously when executing a conversion calculation, in a conversion method from YCbCr 4:2:0 sub-sampling format to RGB of an image processing apparatus according to an exemplary embodiment;

FIG. 5 is a schematic diagram illustrating a reducing of resolution and conversion, when converting YCbCr 4:2:0 sub-sampling format to ½ RGB in an image processing apparatus according to an exemplary embodiment;

FIG. 6 is a schematic diagram illustrating a location S of a pixel in an original image, after executing coordinates conversion for a destination image, as well as four adjacent pixels A, B, C, and D around the location S in the original image in an image processing apparatus according to an exemplary embodiment;

FIG. 7 is a schematic diagram illustrating a configuration of an image processing apparatus according to an exemplary embodiment;

FIG. 8 is a schematic diagram illustrating a configuration of an image processing apparatus according to another exemplary embodiment; and

FIG. 9 is a flowchart illustrating an image processing apparatus according to an exemplary embodiment.

### DETAILED DESCRIPTION OF EXEMPLARY EMBODIMENTS

Exemplary embodiments may be embodied in many different forms and should not be construed as limited to exemplary embodiments set forth herein. Descriptions of well-known parts are omitted for clarity and conciseness, and like reference numerals refer to like elements throughout.

To make objectives, technical solutions, and advantages more clear, detailed descriptions of exemplary embodiments are further provided in the following, accompanying with attached figures.

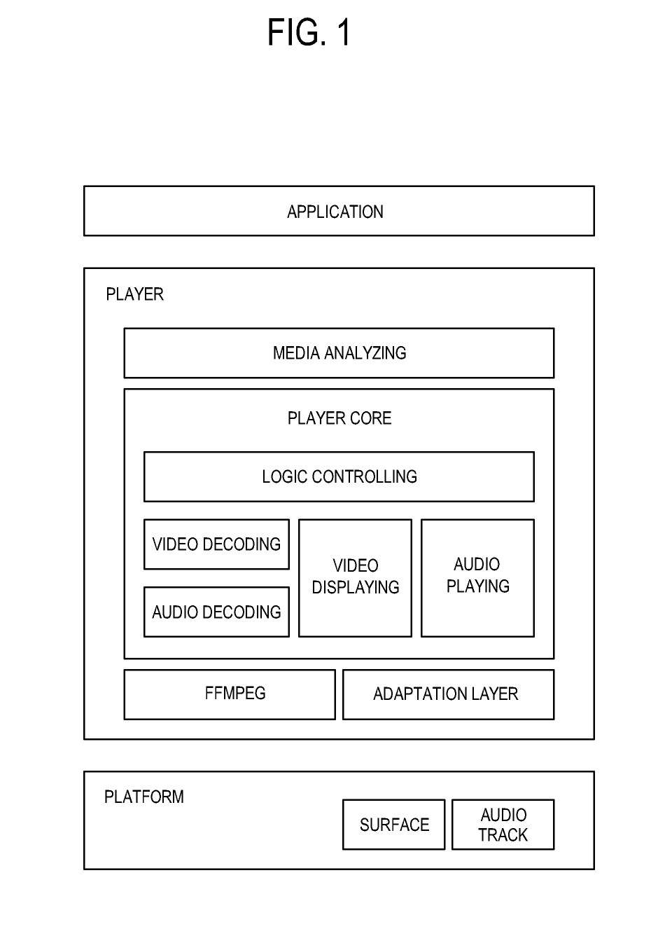

A structure of a multimedia software player based on an embedded device is similar to that of software of an image processing apparatus based on a platform. FIG. 1 is an example illustrating a structure of software of an image processing apparatus on a platform according to an exemplary embodiment. In the example illustrated in FIG. 1, the top layer is an application layer (e.g., an ANDROID application layer), which may call a player by employing JAVA and JAVA NATIVE INTERFACE (JNI) local functions. An image processing apparatus may include a media analyzing module and a player. The media analyzing module is in charge of analyzing a file transfer protocol and a multimedia file format. The player is a logic core of the whole player. The player may include a logic controlling module, a video decoding module, an audio decoding module, a video displaying module, and an audio playing module. Each module starts a thread. The logic controlling module may start a main thread, de-multiplex multimedia data, and execute logic controlling for the whole image processing apparatus. The other four modules may respectively start a thread to decode video, display, decode audio, and play. Modules for decoding audio and video may respectively call an open-source multimedia software framework, e.g., FFMPEG, to execute software decoding. By calling an ANDROID adapter module, the displaying module of the video may employ Surface interface of the ANDROID platform to display the video. The playing module of audio may employ an Audio Track interface of the ANDROID system to play the audio. The Surface and Audio Track interfaces of the ANDROID platform are common software interfaces of the ANDROID platform.

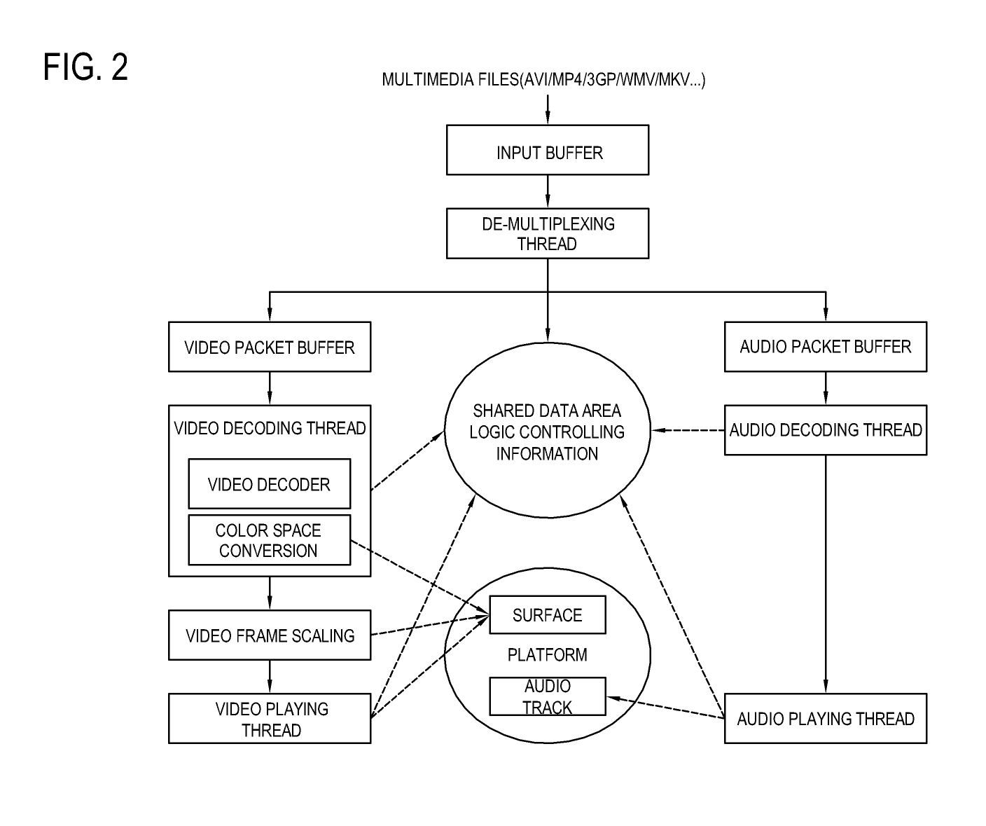

Logic constitution of a multithread player core is shown in FIG. 2. A de-multiplexing thread may read inputted multimedia data through an input buffer, execute de-multiplexing, output data packets of an original stream (such as a frame of compression data of MPEG-4 and H.264) to be respectively stored into an audio packet buffer and a video packet buffer. An audio decoding thread and a video decoding thread may read data packets from a respective input buffer, call FFMPEG software decoder to decode, as well as output decoded YCbCr data and pulse-code modulation (PCM) data, and execute RGB conversion for the YCbCr data outputted by the video decoder. After being scaled, the converted RGB data may be adjusted to a size corresponding to (e.g., equal to) that of a Surface frame buffer, and may be directly written into the Surface frame buffer. Thus, the system memory to be allocated and operated may be omitted when displaying a video frame. A video displaying thread may access shared data and logic controlling information, so as to control a displaying time point of RGB data in each frame buffer, as well as execute logic controlling similar to or same as that executed by an audio playing thread, so as to achieve synchronous playing of audio and video frames.

Based on an analysis of the related art and compared with the related art, the following aspects have been improved according to an image processing apparatus and method of an exemplary embodiment:

1) In the related art technical solution for optimizing a video decoder, each module is generally optimized independently, instead of being combined and optimized. Thus, pertinence and a universal property for the whole video player are lower, and an optimization degree is limited.

2) In the related art video decoding optimization method, adaptive frame loss methods employ uniform re-sampling of time or a complicated adaptive frame loss algorithm based on image contents.

3) In the related art optimization algorithm of color space conversion, algorithm-level optimization and specific optimization operations based on hardware may be employed, so as to improve conversion speed.

An optimization method, according to an exemplary embodiment, for the video decoding module and the displaying module in the multimedia software player based on an embedded device or a platform, includes the following aspects: a dynamic adaptive frame loss method based on decoding speed, a rapid conversion method from YCbCr to RGB color space, and a method for rapidly scaling an image of any proportion. Detailed descriptions are as follows.

1) A Dynamic Adaptive Frame Loss Method Based on the Decoding Speed

Functions of the frame loss method are to execute down-sampling for a video frame at a time axis (e.g., the down-sampling of a video with 30 frames/second to a video with 20 frames/second, such that a sampling rate is 3:2). Video frame rate may be reduced when user's perception is not reduced, so as to accelerate an average speed of video decoding. The algorithm is a dynamic adaptive frame loss method based on the decoding speed, which includes two blocks of loss decoding and loss displaying. In the first block of loss decoding, a video frame selected to be discarded may not be processed, and instead, inputted data may be directly discarded. In the second block of loss displaying, a video frame selected to be discarded is decoded, instead of storing and displaying a video frame outputted after being decoded. Specifically, the method includes three operations as follows:

i) Selecting Mechanisms of the Loss Decoding and Loss Displaying

In a video sequence, due to existence of inter prediction, discarding an arbitrary frame of data without decoding may enable a reference frame to be missing when decoding subsequent frames, which may further lead to decoding mismatching as well as error propagation of a prediction chain. The basis for selecting the loss decoding or loss displaying in the method is as follows. Based on a destination frame rate, during the loss decoding, an image, which may not be taken as a reference frame of another frame, may firstly be selected to discard. When such an image does not exist, or a frame rate cannot be reduced to reach the destination frame rate even if such an image has been discarded, the method of loss displaying may be employed.

ii) Loss Decoding Method

None of a common bi-predictive picture (B) frame, a lowest-level B frame of a hierarchical B frame, a lowest-level predicted picture (P) frame of a hierarchical P frame, and the last frame of a P frame within a closed-loop Group of Pictures (GOP) may be taken as a reference image of another frame. Thus, these frames are selected as discardable frames in the method according to the present exemplary embodiment. Based on a calculation result of destination frame rate and original frame rate, a decoder may select from the discardable frames, so as to select all of or part of the discardable frames to discard. That is, the decoder will not process input data about these frames, update a buffer, and index a reference image. Instead, the decoder may directly discard input data packets, and wait for a next frame of input data. By adopting the method, whole frame decoding, color space conversion, scaling, and displaying duration of several frames may be saved. Subsequently, an average decoding and displaying speed of video may be greatly improved.

iii) Loss Displaying Method

When there is no B frame, hierarchical P frame, or closed-loop GOP within the GOP structure, or the loss decoding method described in ii) still cannot reduce the original frame rate to reach the destination frame rate, the method according to the present exemplary embodiment may further select the loss displaying method. Such a method may not change a decoding process, that is, all the video frames are decoded. However, the discardable frames selected may not output a decoded image, so as to save duration of color space conversion, scaling, and displaying of these frames. Specifically, the method for selecting the discardable frames may be as follows:

Calculate frame loss rate f (e.g., by subtracting the frame loss rate obtained in above block from the destination frame loss rate) in the block. Calculate decoding time t, of a current frame and an average decoding time tₐ of all the other frames in front of current frame, for every N frames. Suppose real-time frame loss rate based on fᵣ=f×t_{c}÷tₐ and N frames are a real-time frame loss unit. In a real-time frame loss unit, a strategy of uniform frame loss may be employed. The frame loss rate is fᵣ. In a real-time frame loss unit, select discardable frames according to the frame loss rate. By employing the real-time frame loss rate, the frame loss rate in a duration in which decoding is slower is improved. Furthermore, the frame loss rate in a duration in which decoding is faster is reduced. However, in a unit of N frames, the strategy of uniform frame loss may be employed. Thus, the average speed for playing video may be improved, without affecting smoothness of video playing and user perception.

Besides, independent of a method for discarding late video frames by a player, the discarded video frames selected by the method will not be outputted from a decoder. The objective thereof is to reduce late video frames in an audio and video synchronization logic to the largest extent.

2) a Method for Rapidly Converting YCbCr into RGB Color Space

During the conversion from an YCbCr image outputted by a decoder to the RGB color space, large amounts of system resources and calculations may be consumed by a floating-point operation, a memory operation, and point-by-point calculation. The application according to an exemplary embodiment optimizes the conversion method, which includes the following blocks.

i) Algorithm-Level Optimization

The algorithm-level optimization includes the following aspects from YCbCr to RGB conversion calculation, such as fixed-point processing, remove multiplication, multi-point calculation simultaneously, table querying to remove addition as well as amplitude limiting calculation, so as to greatly reduce calculations which consume CPU resources.

ii) A Resolution-Reduced RGB Conversion

When resolution of the YCbCr image is larger than a size of a destination displaying buffer, and a user selects a playing option that prioritizes fluent (e.g., fluid) reproduction, the application may execute the resolution-reduced RGB conversion proportional for a decoded image (that is, narrow the horizontal and vertical lengths with the same proportional), to enable a size of the converted RGB image to be close to a size of the destination displaying buffer. The resolution-reduced RGB conversion with proportion of ½, ⅓, ¼, . . . , 1/16 may be included. By adopting the method, a number of pixels used in the RGB conversion calculation may be greatly reduced, and conversion speed may be improved.

iii) Parallel Conversion

For a software decoder supporting parallel multi-thread decoding, a YCbCr-to-RGB conversion module may operate prior to the end of each decoding thread. Thus, the conversion module may be cascaded with a decoding module within a respective decoding thread. A conversion operation for each frame image is also parallel. By adopting the method, optimization results for a multi-core platform are significant. For a single-core platform, the method may also improve decoding speed and conversion speed to some extent, without affecting performances of the whole player.

3) A Method for Rapidly Scaling an Image of any Proportion

A size of the converted RGB image may be different from that of the destination displaying buffer. By adopting a method for rapidly scaling an image of any proportion, the application may enable size of an outputted image to be the same as that of the destination displaying buffer, which includes the following:

i) Non-Memory Operation to Directly Write into a Destination Displaying Buffer

To avoid redundant memory allocation and memory operations, before scaling each frame image, the scaling module may obtain an address pointer of the destination displaying buffer via an adaptation layer. The scaling module may directly write a destination image into addresses pointed by the address pointer, without allocating memory for the destination image. Subsequently, the video displaying module may determine when to display the RGB image that has already been written into the address.

ii) Select Scaling Method and Displaying Manner Based on Scaling Proportion

For images with different resolutions, different scaling or displaying manners may be employed.

When image resolution is smaller than ½ screen size (that is, horizontal length of the image is smaller than ½ horizontal length of the destination displaying buffer, and vertical length of the image is smaller than ½ vertical length of the destination displaying buffer), enlarge the image with a bilinear interpolation. During the enlargement process, a ratio of width and height of an original image may be maintained. A side, the length of which is smaller than a full-screen size, may be put into a central location of a corresponding side on a displaying area. Each area at both sides with smaller sizes may be displayed as black sides (RGB component has an initial value 0). The reason is that decoding speed of a small resolution image is fast enough. Subsequently, the bilinear interpolation with complicated calculation amount and better image enlargement quality may be employed.

Otherwise, when image resolution is smaller than or equal to a screen size (that is, horizontal and vertical lengths of the image are smaller than or equal to a corresponding size of the destination displaying buffer), the image may not be scaled. Instead, the image may be directly copied to a center of the displaying area. The remaining displaying area may be displayed as black edges. The reason is that image resolution is close to the displaying size. The image may be directly displayed with the original size. Image enlargement calculation may be omitted, so as to save time.

Otherwise, narrow the image to a screen size with a nearest neighbor method. During the narrowing process, the ratio of width and height of an original image may be maintained. A side, the length of which is smaller than a screen size, may be put into a central location of a corresponding side on the displaying area. Each area at both sides smaller than the size may be displayed as black edges. The reason is that quality of an image narrowed with the nearest neighbor method is close to that narrowed by the bilinear interpolation. However, a calculation amount of the nearest neighbor method is much smaller than that of the bilinear interpolation.

iii) Algorithm-Level Optimization of the Bilinear Interpolation and Nearest Neighbor Method

Both the bilinear interpolation and the nearest neighbor method execute a floating-point operation for pixel coordinates. The largest calculation amount may be occupied by calculating coordinates. Thus, the application firstly executes fixed-point optimization for the two methods. Subsequently, when calculating a first frame, establish a table for coordinates to be used when calculating coordinates. Further, coordinates of all the frames may be obtained by querying the table and a simple addition operation, without complex calculating.

The nearest neighbor method may not calculate pixel values. Thus, three color components of a pixel may be simultaneously processed when calculating once. For example, regarding RGB565 format, operations of pixel values of about two bytes may be executed once. Subsequently, calculation amount may be further reduced.

The following advantages may be obtained by the application according to the present exemplary embodiment. After several optimizations have been made to video decoding and displaying in a multimedia software player, which is based on an embedded device or an ANDROID platform, a common video format (MPEG-1/2/4, H.264, etc.) with SD resolution (720*480p, 720*576i), or with 720p resolution (1280*720), or partial with HD resolution (1920*1080), may be fluently played. Compared with a corresponding algorithm that is not optimized, the three primary optimization blocks may respectively reduce an average calculation amount by 30% (⅓ frame loss rate), 75% (RGB conversion without reducing resolution, six threads are employed by a dual-core CPU to decode and convert in parallel), and higher than 90% (resolution reduction from HD to 1024*562).

Detailed descriptions of the application are further provided in the following, accompanied by a specific example.

1) Basic Playing Procedure of a General Multimedia Software Player

The basic playing procedure of a multimedia software player is as follows:

Block 1: a user starts an application program of a player, selects an input file. The player is then started.

Block 2: a media analyzing module analyzes a File Transfer Protocol (FTP), calls functions of a corresponding protocol to read multimedia data, analyzes file format and codec information, initializes corresponding resources of FFMPEG, and initializes player core.

Block 3: based on media information outputted by the media analyzing module, the player core starts corresponding resources, opens and configures audio and video software decoder, as well as audio and video player, starts a main logic controlling thread, a video decoding thread, a displaying thread, an audio decoding thread and a playing thread.

Block 4: the main logic controlling thread obtains size and address of frame buffer, configures the size for the video decoding thread, configures the size and address for a video frame scaling module.

Block 5: the video decoding thread configures the FFMPEG software decoder, starts a multi-thread decoding manner thereof, and configures a parallel thread number TC. The FFMPEG starts multi-thread decoding according to configurations, waits for input data and decodes in parallel.

Block 6: the main logic controlling thread starts to read file data, and stores the file data into an input buffer of FIG. 2. When a data amount in the buffer is larger than a preset threshold TH₁ the main thread starts to de-multiplex audio and video data with FFMPEG.

Block 7: the de-multiplexed audio and video data outputted may be respectively stored into an audio packet buffer and a video packet buffer in FIG. 2. When a total amount of the audio and video data stored in a packet buffer is larger than a preset threshold TH₂, a number of audio packets is larger than a preset threshold TH₃, a number of video packets is larger than a preset threshold TH₃, the audio and video decoding thread respectively reads audio and video packets from the buffer to be decoded. In the video decoding process with parallel multi-threads, the conversion from YCbCr to RGB color space may also be executed in parallel.

Block 8: after starting to decode the audio and video, since non-uniform speed change of de-multiplexing, audio and video decoding, as well as playing, the main logic controlling thread may start a buffer mechanism, to avoid memory usage overflowing, output data inputting and consumption speed compared with smooth de-multiplexing. When starting to play normally, buffer state is denoted by Playing. When there is no audio or video data in the audio and video packet buffer, inform the audio and video decoding thread and the playing thread to suspend. At this time, the audio and video packet buffer may have input data instead of output data. State of the audio and video packet buffer may be denoted by Buffering. When the audio and video packet buffer is in the Buffering state, a total amount of the audio and video data in the audio and video packet buffer is larger than the preset threshold TH₄, each of audio packet number and video packet number is larger than the preset threshold TH₃, inform the audio and video decoding thread and the playing thread to resume, and update buffer state as Playing. When the state of the audio and video packet buffer is Playing, total data amount in the audio and video packet buffer is larger than the threshold TH₂, suspend the de-multiplexing. At this time, the audio and video packet buffer may only have input data without output data, to avoid memory usage overflowing. Furthermore, a state of the audio and video packet buffer may be amended to Consuming. When the state of the audio and video packet buffer is Consuming, a total amount of the audio and video data in the audio and video packet buffer is smaller than the preset threshold TH₄, resume the de-multiplexing. Amend the state of the audio and video packet buffer as the Playing state indicating normal playing. At this time, the audio and video packet buffer may have input data and output data.

Block 9: after successfully outputting a frame of decoded audio and video data by the audio and video decoding thread, the audio and video decoding thread as well as the video displaying thread may respectively read the frame data, to obtain a time of a current system compared with a time point for starting to play the first frame video, take the obtained time of the current system as system clock STC, and compare with a displaying timestamp PTS of a frame of audio or video outputted after being decoded. When STC<PTS and PTS-STC<TH₅, or STC>PTS and STC-PTS<TH₆, input a current audio frame to Audio Track to be played, or output an RGB image of a current video frame to the video scaling module. Otherwise, when STC<PTS, the audio playing thread or video displaying thread may wait for 5 milliseconds, and then continues to compare. Otherwise, when a current audio and video frame is determined to be late, the frame may still be played or displayed. However, the system clock STC=STC−(STC−PTS) is updated in this case. The objective thereof is to guarantee smooth playing of current video and allow the system clock to slow down.

Block 10: after obtaining the RGB image of a current video frame, the image scaling module may rapidly scale the image, to enable the image size to be equal to that of the Surface frame buffer, and directly write the scaled image into the destination displaying buffer to be displayed.

Above blocks 1˜10 are basic procedures, when the player opens and plays a media file normally. The threshold values and constants therein, TC, TH₁, TH₂, TH₃, TH₄, TH₅, TH₆ are preset configuration values (e.g., TC=6, TH₁=TH₂=5 M bytes, TH₃=30, TH₄=3 M bytes, TH₅=TH₆=10 milliseconds).

2) A Specific Example in which a Dynamic Adaptive Frame Loss is Based on Decoding Speed

In the application according to the present exemplary embodiment, functions of the dynamic adaptive frame loss method based on decoding speed are to execute down-sampling for a video frame at a time axis. Reduce video frame rate without reducing user perception, so as to optimize an average speed for decoding video.

Block 1: after obtaining codec format information, a decoder may set destination a frame rate fₜ, based on a codec format, bit rate, original frame rate f (frame/second), grade, and level information. For example, in an exemplary embodiment, set the destination frame rate to be 20 frames/second, for H.264 video, 1280*720 resolution, HP grade, 4.0 level, 8M bit rate, a video with frame rate 30 frames/second. And then, time sampling rate is 3:2. Calculate frame loss rate f_{d}=f−fₜ, which denotes number of frames to be discarded per second.

Block 2: obtain GOP structure information from the codec format information, determine and execute the following blocks.

a) When there is a common B frame, a lowest-level B frame of a hierarchical B frame, a lowest-level P frame of a hierarchical P frame, the last frame of P frame within a closed-loop GOP, these frames may be defined as discardable frames, denoted by D frame. When a frame rate of the D frame f_{D}>f_{d}, execute a uniform loss decoding for the D frame. That is, discard f_{d} D frames per second evenly. Each discarded D frame is not decoded. No decoding data will be outputted from each discarded D frame. No reference frame buffer or index will be updated for each discarded D frame. Decoder input data of each discarded D frame may be released. No subsequent blocks may be executed by the method.

b) When there is a D frame in the GOP, and a frame rate of the D frame f_{D}≦f_{d}, discard all the D frames. Each discarded D frame is not decoded. No decoding data will be outputted from each discarded D frame. No reference frame buffer or index will be updated for each discarded D frame. Decoder input data of each discarded D frame may be released. No subsequent blocks may be executed by the method. When f_{D}=f_{d}, no subsequent blocks may be executed by the method. Otherwise, subsequent loss displaying block may be executed.

c) When there is no D frame in the GOP, denote f_{D}=0.

d) Calculate the destination frequency of loss displaying f_{R}=f_{d}−f_{D}, which denotes number of frames to be discarded and displayed per second.

e) Suppose length N of a real-time frame loss unit is same as that of the GOP.

Every N−1 frames, calculate decoding time t_{c} of a current frame, and an average decoding time tₐ of all the frames in front of current frame.

g) Calculate the real-time frame loss rate fᵣ=f_{R}×t_{c}÷tₐ.

h) In a real-time frame loss unit, employ the real-time frame loss rate fᵣ to execute uniform loss displaying. That is, a discarded frame selected may not output a decoded image, so as to save time of color space conversion, scaling and displaying of these frames.

By employing the real-time frame loss strategy, the frame loss rate may be improved in a time period in which decoding is slower. The frame loss rate may be reduced in a time period in which decoding is faster. Meanwhile, the strategy of uniform frame loss may be employed in a unit of N frames. Thus, the average speed for playing video may be improved, without affecting smoothness of video playing and user perception.

It should be noted that, the destination frame rate fₜ in the method is a calculation reference value, which is not a frame rate when actually playing. When actually playing, the frame rate may be variable. An average frame rate thereof may be close to the destination frame rate. Since the de-multiplexing thread has already extracted a timestamp for each audio and video packet, when analyzing file format, displaying of other video frames and audio frame synchronization may be not affected by giving up decoding or displaying of some video frames. Besides, independent of a method for discarding a late video frame by a player, the discarded video frames selected by the method may not be outputted from the decoder. The objective thereof is to reduce late video frames to the largest extent in the audio and video synchronization logic.

3) a specific example describing fast conversion from YCbCr to RGB color space

When a destination platform does not support displaying of YCbCr video format, but the destination platform supports image outputting of RGB format, the player executes the RGB color space conversion for the YCbCr image outputted by the decoder. A conversion method from YCbCr to RGB color is as follows:

R=1.164(Y−16)+1.596(Cr−128)

G=1.164(Y−16)−0.813(Cr−128)−0.391(Cb−128)

B=1.164(Y−16)+2.018(Cb−128)

Since large amounts of system resources and calculations are consumed by a floating-point operation, memory operation, and point-by-point calculation, main blocks put forward by the application for optimizing conversion from YCbCr 4:2:0 sub-sampling format to RGB 565 format are as follows:

Block 1: execute an algorithm-level optimization for the conversion calculation, which includes the following blocks:

Block 1-1: execute fixed-point processing for the floating-point operation, employ a scale factor K=1024 to execute 10-bit amplification for a conversion coefficient, and then round a result to the nearest integer. After the fixed-point processing, above conversion formula may be as follows:

R′=1192(Y−16)+1634(Cr−128)+512

G′=1192(Y−16)−832(Cr−128)−401(Cb−128)+512

B′=1192(Y−16)+2066(Cb−128)+512

R′, G′ and B′ are values obtained by respectively magnifying 1024 times of values of R, G and B, that is:

R=R′/1024

G=G′/1024

B=B′/1024

Block 1-2: configure and employ a conversion table, remove multiplication calculation.

A) Define three conversion tables with 32 bits: table T3T1, table T4T2, and table T5. An index of each table is pixel value Y, Cb, or Cr of 0˜255. Meanings of each table are as follows (“<<” denotes a left shift calculation).

aa) Table T3T1 denotes a part with index Cr in the conversion, in which the first 16 digits are

$$\frac{- 832 ( Cr - 128 ) + 512}{1024} ,$$

and the subsequent 16 digits are

$$\frac{1634 ( Cr - 128 ) + 512}{1024} .$$

And then,

$$T 3 T 1 [ Cr ] = [ \frac{- 832 ( Cr - 128 ) + 512}{1024} ≪ 16 ] + \frac{1634 ( Cr - 128 ) + 512}{1024} .$$

bb) Table T4T2 denotes a part with index Cb in the conversion, in which first 16 digits are

$$\frac{2066 ( Cb - 128 ) + 512}{1024} + 4608 ,$$

which include an offset 4608 of initial position of B component in an amplitude limitation table in subsequent blocks.

The subsequent 16 digits are

$$\frac{- 401 ( Cb - 128 )}{1024} + 2304 ,$$

which include an offset 2304 of initial position of G component in the amplitude limitation table in subsequent blocks.

And then,

$$T 4 T 2 [ Cb ] = \{ [ \frac{2066 ( Cb - 128 ) + 512}{1024} + 4608 ] ≪ 16 \} + \frac{- 401 ( Cb - 128 )}{1024} + 2304.$$

cc) Table T5 denotes a part with index Y in the conversion.

$$T 5 [ Y ] = \frac{1192 ( Y - 16 )}{1024} .$$

B) Calculate RGB value with the conversion table, calculation method is as follows:

y_add=T5[Y]

r_add=(short)T3T1[Cr]

g_add=(short)T4T2[Cb]+(short)(T3T1[Cr]>>16)

b_add=(short)(T4T2[Cb]>>16)

R=y_add+r_add

G=y_add+g_add

B=y_add+b_add

“>>” denotes right shift calculation. (short) denotes to extract lower 16 bits of calculation value. Subsequently, three components of RGB of a pixel may be stored with a 16-bit variable of unsigned short type, and the calculation method thereof is as follows:

rgb=(R>>3)<<11|(G>>2)≦≦5|B>>3

“|” denotes a logic OR calculation.

Block 1-3: configure and employ the amplitude limitation table, remove condition, and execute amplitude limitation calculation.

The RGB value obtained in block 1-2 may exceed a [0,255] interval. Thus, before calculating rgb, to the method executes the amplification limitation for the RGB value.

R=R<0?0:(R>255?255:R)

G=G<0?0:(G>255?255:G)

B=B<0?0:(B>255?255:B)

However, two comparisons may be introduced by such a calculation. In the application, optimization may be implemented with the amplitude limitation method. Definition of the amplitude limitation table is as follows:

static unsigned short crop_shift[(256+2*1024)*3]={0,}.

Array crop_shift[ ] may be assigned when initializing the player core, which is as follows:

```
for(int i=0; i<1024; i++)
{
crop_shift[i] = 0;
  crop_shift[2304 + i] = 0;
  crop_shift[4608 + i] = 0;
  crop_shift[i + 1024 + 256)] = (0x1F << 11);
  crop_shift[2304 +(i +1024 + 256)] = (0x3F << 5);
  crop_shift[4608 + (i + 1024 + 256)] = 0x1F;
}
for(int i=0; i<256; i++)
{
  crop_shift[i + 1024] = ((i>>3)<<11);
  crop_shift[2304 + (i + 1024)] = ((i>>2)<<5);
  crop_shift[4608 + (i + 1024)] = (i>>3);
}
```

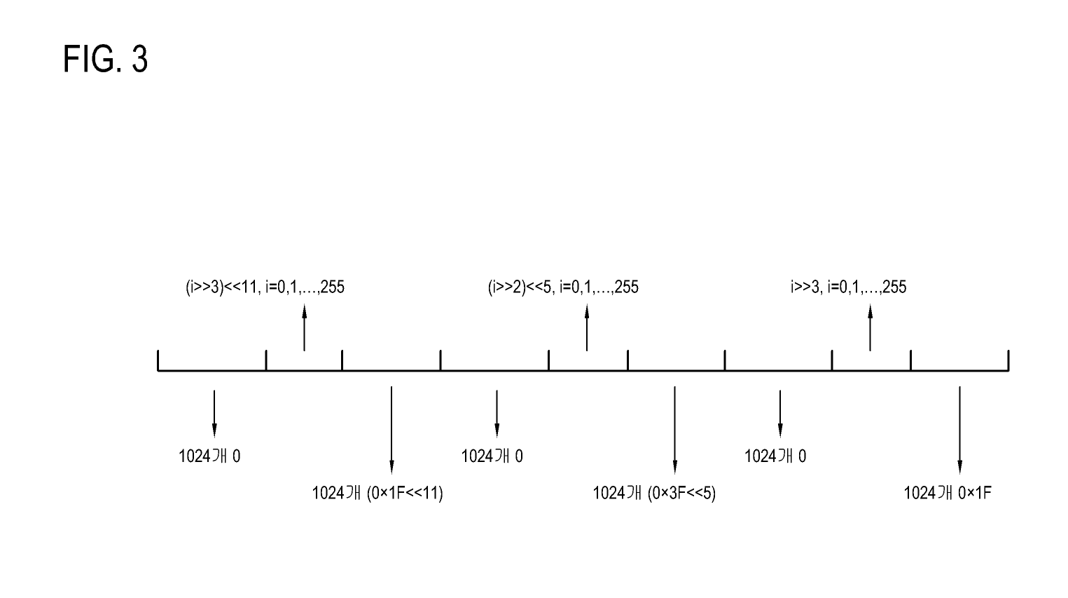

Since a destination format is RGB565, take into account shift operation when denoting 16-bit RGB data with a pixel, length and value of each segment data in the array are shown in FIG. 3.

FIG. 3 shows three divided intervals with uniform data length of 2304. Each interval therein may be further divided into three subintervals, the data length thereof is respectively 1024, 256 and 1024, and then there are 9 subintervals in all. Each subinterval in the three intervals from left to right is respectively denoted as follows:

1) value 0, number of which is 1024, that is, when R/G/B component in RGB565 is smaller than 0, amplitude thereof may be limited to 0.

2) 256 values, which are respectively 0-255, and may be denoted by 5/6/5 bits of the R/G/B component in the RGB 565.

3) Maximum value of 1024 R/G/B components may be denoted by 5/6/5 bits of the R/G/B component in the RGB565 by shifting.

Block 1-4: simultaneously calculate with multiple points.

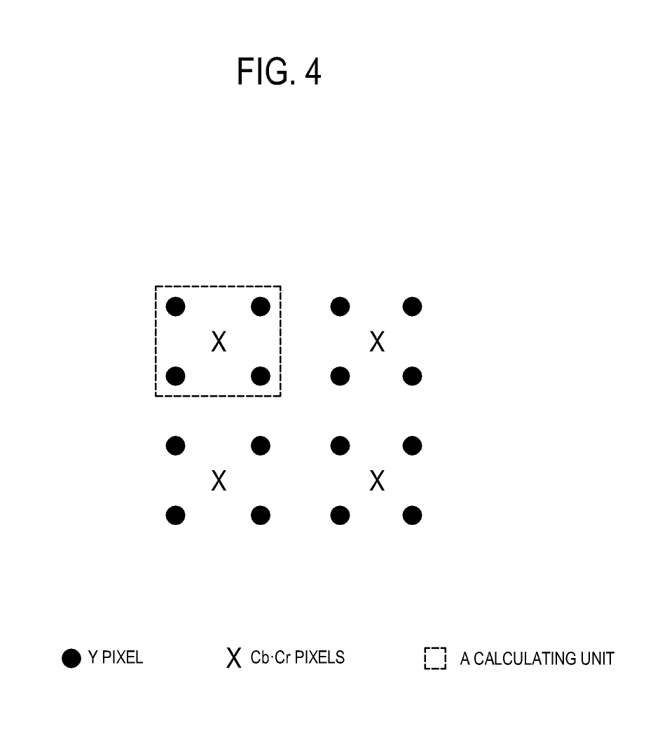

Regarding an image with input format of YCbCr 4:2:0 sub-sampling format, a Cb or Cr pixel corresponds to four Y pixels. Thus, the RGB conversion may be simultaneously executed for the four pixels, the schematic diagram is shown in FIG. 4.

After optimizing by block 1, exemplary codes for converting an image with the YCbCr 4:2:0 sub-sampling format to an RGB565 image are as follows:

```
    rgb0 = (unsigned short*)dest;
    rgb1 = rgb0 + width;
    unsigned short *crop = crop_shift + 1024;
    for (h = height; h>0; h−−)
    {
        for(w = width; w>0; w−=4)
        {
        ...
        ...
          r_add = (short)(T3T1[Cr]);
          g_add = (short)T4T2[Cb] + (short)(T3T1[Cr]>>16));
          b_add = (short)(T4T2[Cb]>>16);
          y_add = T5[y0++];
          *rgb0++ = (unsigned short)(crop[y_add + r_add] |
crop[y_add + g_add] | crop[y_add + b_add]);
          y_add = T5[y0];
          *rgb0++ = (unsigned short) (crop[y_add + r_add] |
crop[y_add + g_add] | crop[y_add + b_add]);
            y_add = T5[y1++];
          *rgb1++ = (unsigned  short)  (crop[y_add  +
r_add] | crop[y_add + g_add] | crop[y_add + b_add]);
          y_add = T5[y1];
          *rgb1++ = (unsigned  short)  (crop[y_add  +
r_add] | crop[y_add + g_add] | crop[y_add + b_add]);
          }
          ...
          ...
          }
```

In above codes, rgb0 is a pointer pointing to destination RGB565 image address. rgb1 is a pixel of next line of rgb0. width and height are respectively width and height of the image. y0 is brightness pixel address of the YCbCr image. y1 is pixel of next line of y0. Cb and Cr are chroma pixel values.

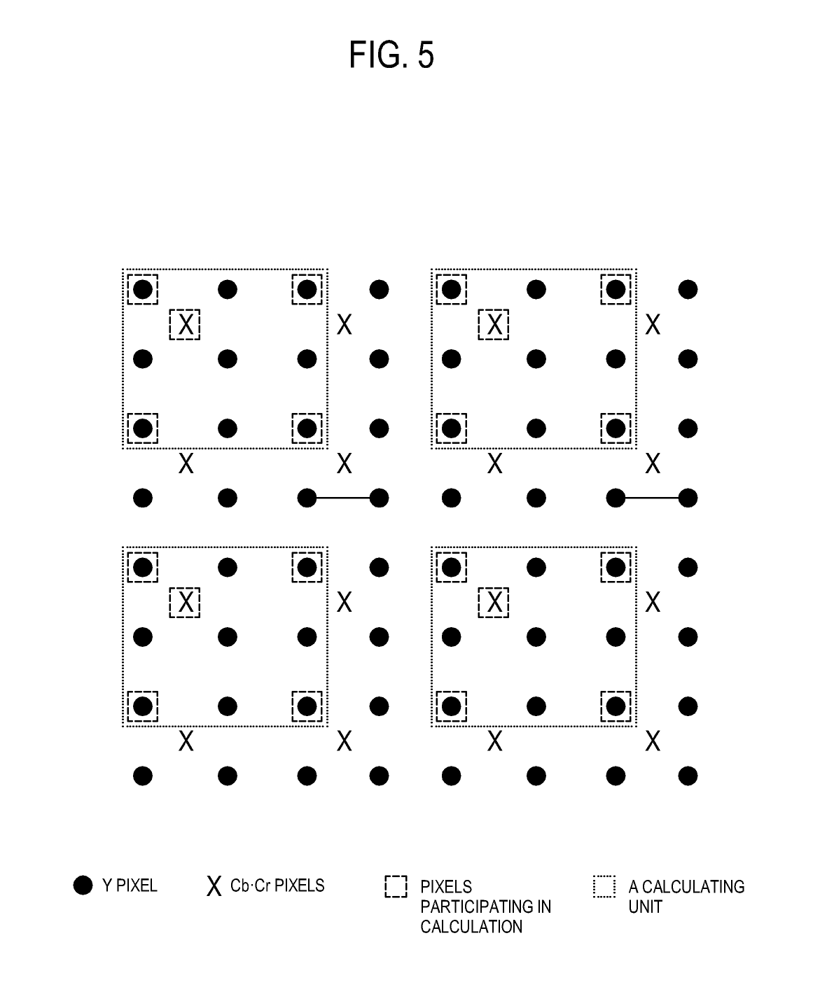

Block 2: when a user selects an option to prioritize a fluent playing (e.g., “firstly fluently playing”) before playing, the resolution-reduced RGB conversion may be implemented with every-point calculation, so as to reduce a number of pixel points participating in the calculation. Subsequently, RGB conversion speed may be further accelerated. FIG. 5 is an example illustrating an RGB conversion with ½ resolution reduced. As shown in FIG. 5, only ¼ pixels (pixels within dashed box) participate in the calculation. Similarly, in the RGB conversion with ⅓ resolution reduced, only 1/9 pixels participate in the calculation, and the like.

Blocks of the resolution-reduced RGB conversion method are as follows:

Block 2-1: calculate ratio 1/R (R is a positive integer) of the reduced resolution, based on width and height of an original image, which are respectively denoted by width and height, as well as width and height of a destination displaying buffer of the RGB converting module configured by the player core, which are respectively denoted by surface_width and surface_height, to enable width/R and height/R to be respectively closest to surface_width and surface_height, that is,

$$R = ⌈ \sqrt{\frac{width \times height}{surface\_width \times surface\_height}} ⌉$$

Block 2-2: in every-point calculation, with reference to FIG. 5, the method respectively selects a pixel every (R−1) pixels in horizontal and vertical directions to participate in the calculation in block 1. Thus, in the whole image, only width×height/R² pixels participate in the RGB conversion. After the conversion, width and height of the RGB image are respectively width/R and height/R, which may be inputted to a next module to be further processed subsequently.

Block 3: cascade the YCbCr to RGB conversion module with a decoding module within each decoding thread of the FFMPEG, so as to implement the parallel RGB conversion

4) a specific example in which an image of any proportion is scaled rapidly

A size of the converted RGB image is width×height, or (width/R)×(height/R), which may be different from a size of the destination displaying buffer, that is, surface_width×surface_height. In the present exemplary embodiment, a method for rapidly scaling an image of any proportion may be employed, so as to scale an output image to enable the output image to reach a size of the destination displaying buffer. The specific implementation blocks are as follows:

Block 1: non-memory operation to directly write into the destination displaying buffer

To avoid redundant memory allocation and memory operations, before scaling each frame video image, the scaling module may obtain an address pointer of the destination displaying buffer through an adaptation layer. The scaling module may not allocate memory for a destination image, and instead, the scaling module may directly write the destination image into an address pointed by the pointer. Subsequently, the video displaying module may determine when to display the RGB image that has already been written into the address.

Block 2: select a scaling method and displaying mode according to scaling ratio

Regarding images with different resolutions, different scaling or displaying modes may be employed.

Block 2-1: when image resolution is smaller than ½ screen size (that is, a horizontal size of the image is smaller than ½ corresponding size of the destination displaying buffer, a vertical size of the image is also smaller than ½ corresponding size of the destination displaying buffer), enlarge the image with the bilinear interpolation. During the enlargement process, a ratio of width and height of an original image may be maintained. A side, the length of which is smaller than a full-screen size, may be put into a central location of a corresponding side on a displaying area. Each area at both sides with smaller size may be displayed as black edges (RGB component is an initial value 0). The reason is that decoding speed of a small resolution image is fast enough. Subsequently, the bilinear interpolation with a complicated calculation amount and better image enlargement quality may be employed.

Block 2-2: otherwise, when image resolution is smaller than or equal to a screen size (that is, horizontal and vertical lengths of the image are smaller than or equal to a corresponding size of the destination displaying buffer), the image may not be scaled. Instead, the image may be directly copied to a center of the displaying area. The remaining displaying area may be displayed as black edges. The reason is that image resolution is close to the displaying size. The image may be directly displayed with an original size. Image enlargement calculation may be omitted, so as to save time.

Block 2-3: Otherwise, narrow the image to screen size with a nearest neighbor method. During the narrowing process, the ratio of width and height of the original image may be maintained. A side, the length of which is smaller than a screen size, may be put into a central location of a corresponding side on the displaying area. Each area at both sides smaller than the size may be displayed as black edges. The reason is that quality of an image narrowed with the nearest neighbor method is close to that narrowed by the bilinear interpolation. However, a calculation amount of the nearest neighbor method is much smaller than that of the bilinear interpolation.

Block 3: algorithm-level optimization of the bilinear interpolation and the nearest neighbor method

A) the bilinear interpolation and the nearest neighbor calculation method

Suppose width and height of an image to be scaled are respectively W and H, and then, W=width or width/R (the resolution-reduced RGB conversion is employed), and H=height or height/R (the resolution-reduced RGB conversion is employed). The destination image is destination displaying buffer, size of which is surface_width and surface_height. Calculate the scaling ratio r:

$$r = min [ \frac{surface\_width}{W} , \frac{surface\_height}{H} ]$$

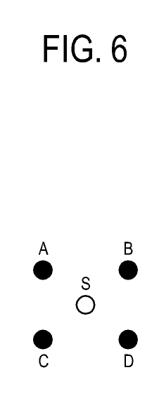

r is a floating point number, and min represents the minimal value. r is a uniform scaling ratio factor of the horizontal and vertical directions. As shown in FIG. 6, in the destination image, any point S with coordinates (x, y) may be converted into a position in an original image with coordinates

$$( \frac{x}{r} , \frac{y}{r} )$$

with ratio r. Coordinates

$$( \frac{x}{r} , \frac{y}{r} )$$

are floating point number, the adjacent pixels thereof in the original image are A, B, C and D.

aa) a method for calculating pixel value of point S with the nearest neighbor method is:

S=A

That is, execute an inverse conversion for the scaled image to obtain floating-point coordinates. Round the floating-point coordinates to obtain integer coordinates. A pixel value in the original image corresponding to the integer coordinates is a pixel value of a scaled destination pixel. Calculation of the method is simple, and calculation speed is rapid. However, the method may enable the scaled image to possess aliasing effects.

bb) a method for calculating pixel value of point S with the bilinear interpolation is:

S=¼(A+B+C+D)

That is, execute the inverse conversion for the scaled image to obtain floating-point coordinates. Execute a weighed calculation for four pixels around a position in an original image corresponding to the floating-point coordinates, according to a certain weight, to obtain a pixel value, which is a pixel value of a scaled destination pixel. In the present exemplary embodiment, four ¼ may be taken as weight, that is, 4-tap averaging filters. The 4-tap averaging filters may possess smooth functions of a low pass filter, which may eliminate aliasing to a large extent. However, the 4-tap averaging filters may also enable scene outline to be fuzzy.

Compare the two methods with each other, by employing the nearest neighbor method, calculation amount may be smaller. However, image quality may be worse and there may be more aliasing, when enlarging an image with a larger ratio. When narrowing an image with a larger ratio, image qualities of the two methods are close. Thus, the application employs the selection method about the scaling and displaying in block 2, so as to compromise image quality and calculation amount.

B) the bilinear interpolation and the nearest neighbor calculation optimization method

When scaling an image with the two methods, the most time-consuming operation is to calculate floating-point pixel coordinates. In the application, the following blocks may be employed to optimize the two methods:

aa) calculate flag useX:

When

$$\frac{surface\_width}{W} < \frac{surface\_height}{H} ,$$

useX=1; otherwise, useX=0.

UseX represents whether to take a scaling ratio of X axis as a uniform scaling ratio. When useX=0, useX represents to employ scaling ratio of y axis. When useX=1, useX represents to employ the scaling ration of x axis.

bb) calculate top left corner coordinates of screen displaying area in the destination displaying buffer and size of the displaying size, which may be as follows:

```
if(useX == 1)
{
  startX = 0;
  width = surface_width;
  height = H * surface_width / W;
  startY = MAX((surface_height − height)/2 − 1, 0);
}
else
{
  startY = 0;
  width = W * surface_height / H;
  height = surface_height;
  startX = MAX((surface_width − width)/2 − 1, 0);
}
```

cc) Define four global arrays, to represent integer coordinates conversion table, which may be as follows:

static int*T_{—}yWyH;

static int*T_{—}xWxH;

static int*T_{—}corDst;

static int*T_{—}corSrc;

When scaling the first frame video image, allocate space and execute assignment for the coordinates conversion table, which may be as follows:

```
T_yWyH = (int*)malloc((height+1) * sizeof(int));
T_xWxH = (int*)malloc((width +1) * sizeof(int));
T_corDst = (int*)malloc((height+1) * sizeof(int));
T_corSrc = (int*)malloc((height+1) * sizeof(int));
for(y=0; y<height; y++)
{
  T_yWyH[y] = (useX? (y * W / surface_width) : (y * H /
  surface_height));
  T_corDst[y] = (y + startY) * surface_width;
  T_corSrc[y] = T_yWyH[y] * W;
}
for(x=0; x<width; x++)
{
  T_xWxH[x] = (useX? (x * W / surface_width) : (x * H /
  surface_height));
}
```

dd) During the scaling process of each frame, write pixel value of final image into address (16 bit unsigned short pointer dest) of the destination displaying buffer.

According to an exemplary embodiment, the following method may be employed to implement scaling of the nearest neighbor method:

```
    int destY, srcY;
    for(y=0; y<height; y++)
    {
      destY = T_corDst[y];
      srcY = T_corSrc[y];
      for(x=0; x<width; x++)
      {
      dest[destY  + (x+startX)] = src[srcY  +
T_xWxH[x]];
      }
    }
```

According to an exemplary embodiment, the following method may be employed to implement scaling of the bilinear interpolation:

```
    unsigned short destR, destG, destB;
    unsigned short srcR00, srcG00, srcB00;
    unsigned short srcR01, srcG01, srcB01;
    unsigned short srcR10, srcG10, srcB10;
    unsigned short srcR11, srcG11, srcB11;
    int destY, srcY0, srcY1, srcX0, srcX1;
    for(y=0; y<height; y++)
    {
      destY = T_corDst[y];
      srcY0 = T_corSrc[y];
      srcY1 = T_corSrc[y+1];
      for(x=0; x<width; x++)
      {
      srcX0 = T_xWxH[x];
      srcX1 = T_xWxH[x+1];
      srcR00  = ((src[srcY0  + srcX0] &  0xf800)  >> 11)
<< 3;
      srcG00  = ((src[srcY0  + srcX0] &  0x07e0)  >> 5)
<< 2;
      srcB00 = (src[srcY0 + srcX0] & 0x001f) << 3;
      srcR01  = ((src[srcY1  + srcX0] &  0xf800)  >> 11)
<< 3;
      srcG01  = ((src[srcY1  + srcX0] &  0x07e0)  >> 5)
<< 2;
      srcB01 = (src[srcY1 + srcX0] & 0x001f) << 3;
      srcR10 = ((src[srcY0 + srcX1] & 0xf800) >>11) << 3;
      srcG10  = ((src[srcY0  + srcX1] &  0x07e0)  >> 5)
<< 2;
      srcB10 = (src[srcY0 + srcX1] & 0x001f) << 3;
      srcR11  = ((src[srcY1  + srcX1] &  0xf800)  >> 11)
<< 3;
      srcG11  = ((src[srcY1  + srcX1] &  0x07e0)  >> 5)
<< 2;
      srcB11 = (src[srcY1 + srcX1] & 0x001f) << 3;
      destR = (srcR00 + srcR01 + srcR10 + srcR11) >> 2;
      destG = (srcG00 + srcG01 + srcG10 + srcG11) >> 2;
      destB = (srcB00 + srcB01 + srcB10 + srcB11) >> 2;
      dest[destY + (x+startX)] = ((destR>>3)<<11) | ((destG>>2)<<5) | (destB>>3);
    }
    }
```

As mentioned above, after being optimized by fixed point and coordinates conversion table, the two scaling methods include integer addition, table querying, and simple logic calculation, the calculation amounts thereof are reduced greatly. Besides, based on above descriptions, it can be seen that a calculation amount of the bilinear interpolation is several times that of the nearest neighbor method. 16 digits RGB value of a pixel may be simultaneously processed by the nearest neighbor method. Thus, in the present exemplary embodiment, the bilinear interpolation may be employed to enlarge an image with minimal resolution and rapid decoding speed. Meanwhile, the nearest neighbor method may be employed to narrow a large image with slower decoding speed.

After processing the last frame image, release space of the four coordinates conversion tables, and reset resources.

Based on above-described exemplary embodiments, it can be seen that all the modules in the multimedia software player, which is optimized by aspects of exemplary embodiments, may be implemented with software independent of hardware, which is a multimedia playing method with a universal property. Moreover, the multimedia playing method may support various video formats.

Furthermore, one or more exemplary embodiments combine and optimizes video decoding, color conversion, image scaling, decoding speed controlling, video frame displaying, system memory usage, and frame buffer usage, thus improving fluency of video playing. By adopting an exemplary embodiment, which possesses a universal property, CPU and system resource occupancy rate may be effectively reduced, so as to improve playing fluency.

Regarding the image processing apparatus according to an exemplary embodiment, terms used in the aforementioned exemplary embodiment may be defined as follows.

The term “frame dropping” may mean discarding a frame or reducing the number of frames.

The term “rate of a frame” may be referred to as a frame rate hereinafter.

The term “loss decoding” may mean reducing the number of frames to be subject to image processing or discarding a frame.

The term “loss displaying” may mean reducing the number of frames by image processing without image outputting or discarding a frame.

A destination frame may refer to a frame of an output image.

A destination frame rate may refer to a frame rate of an output image

An original frame rate may refer to a frame rate of an input image.

A destination frame dropping rate may refer to a rate of reducing the number of frames of an output image or discarding frames.

A real-time frame dropping rate may refer to a real-time frame reduction rate.

A decoder may refer to a decoding unit to decode an input image.

The foregoing terms may be applied to the description of an image processing apparatus according to an exemplary embodiment, which will be made below.

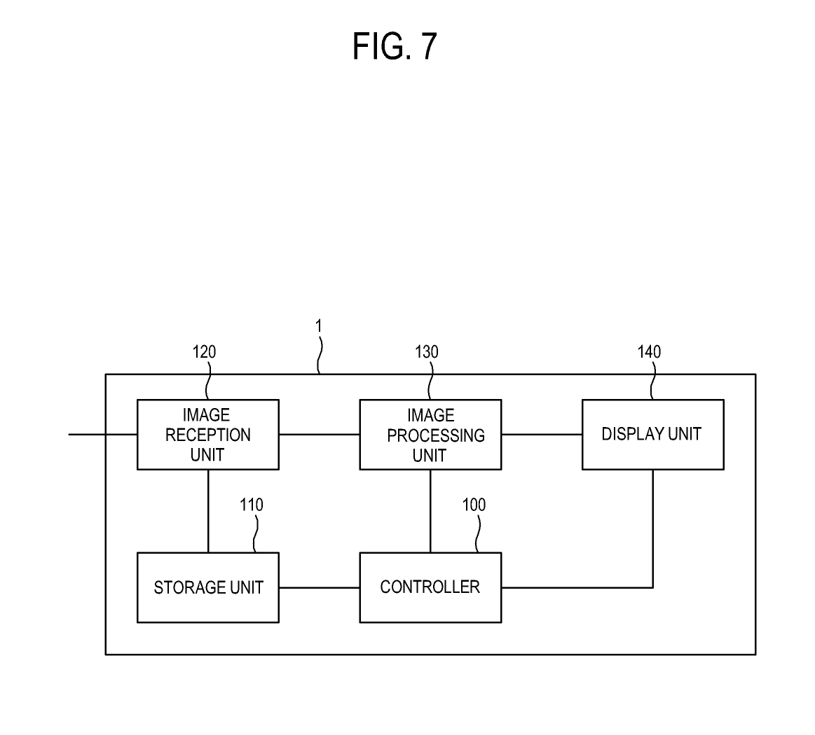

FIG. 7 is a schematic diagram illustrating a configuration of an image processing apparatus 1 according to an exemplary embodiment. The image processing apparatus 1 according to the present exemplary embodiment may include an image reception unit (e.g., image receiver) 120, an image processing unit (e.g., image processor) 130, a display unit (e.g., display) 140, a storage unit (e.g., storage) 110, and a controller 100.

The image reception unit 120 receives an image signal/image data via a wire or wirelessly and transmits the signal/data to the image processing unit 130. The image reception unit 120 may be configured as various forms corresponding to standards of received image signals and configurations of a display apparatus. For example, the image reception unit may receive a radio frequency (RF) signal or image signals in accordance with composite video, component video, super video, SCART, high definition multimedia interface (HDMI), Display Port, unified display interface (UDI), or wireless HD standards. When an image signal is a broadcast signal, the image reception unit 120 includes a tuner to tune the broadcast signal by each channel. The image reception unit 120 may receive a broadcast signal from a broadcast signal transmission unit (e.g., broadcast signal transmitter), for example, a TV broadcast signal, as an image signal, receive an image signal from an imaging device, such as a digital versatile disc (DVD) player and a Blu-ray disc (BD) player, receive an image signal from a personal computer (PC), receive an image signal from mobile equipment, such as a smartphone and a smart pad, receive an image signal through a network, such as the Internet, or receive image content stored in a storage medium, such as a universal serial bus (USB) storage medium, as an image signal. Alternatively, an image signal may be stored and provided from the storage unit 110.

The image processing unit 130 may perform any type of image processing process, without being limited to, for example, decoding in accordance with image formats of image data, de-interlacing to convert an interlaced image signal into a progressive form, scaling to adjust image data to a preset resolution, noise reduction to improve image quality, detail enhancement, frame refresh rate conversion, etc.

The image processing unit 130 may be provided as an integrated multi-functional component, such as a system on chip (SOC), or as an image processing board formed by mounting components which independently conduct individual processes on a printed circuit board and be embedded in a display apparatus. The image processing unit 130 processes an image signal to display an image. Further, the image processing unit 130 may process an image signal to display an image including at least one graphic user interface (GUI) item. An image processed by the image processing unit 130 may be output to a display apparatus, such as a monitor or a TV, and displayed thereon.

The image processing unit 130 may perform any type of image processing process, for example, de-multiplexing to separate a signal into characteristic signals, decoding corresponding to an image format of an image signal, de-interlacing to convert an interlaced image signal into a progressive form, noise reduction to improve image quality, detail enhancement, and frame refresh rate conversion. The image processing unit 130 may include a decoder to decode a source image corresponding to an image format of an encoded source image and a frame buffer to store a decoded source image by a frame unit.

The display unit 140 displays or outputs an image based on an image signal output from the image processing unit 130. The display unit 140 may be configured in various display modes using liquid crystals, plasma, light emitting diodes, organic light emitting diodes, a surface conduction electron emitter, a carbon nano-tube, nano-crystals, or the like, without being limited thereto. The display unit 140 may further include an additional element depending on a display mode thereof. For example, in a display mode using liquid crystals, the display unit may include a liquid crystal display (LCD) panel, a backlight unit providing light to the panel, and a panel drive board driving the panel. Furthermore, it is understood that one or more exemplary embodiments are not limited to an image processing apparatus 1 including a display unit 140. For example, according to another exemplary embodiment, the image processing apparatus 1 may include an output unit (e.g., output) to output a processed image signal to be displayed or further processed by another device.

The storage unit 110 may store data in the case of cutting power supply to the image processing apparatus, and may be configured as a writable read-only memory (ROM) to apply changes of a user. That is, the storage unit may be configured as any one of a flash memory, an erasable programmable read-only memory (EPROM), and an electrically erasable programmable read-only memory (EEPROM).

The controller 100 may control the image processing apparatus 1 overall. In particular, the controller 100 compares an image processing speed of an input image with a frame rate of the input image. Then, when the frame rate of the input image is higher than the image processing speed of the input image, the controller 100 sets a frame rate of an output image to be lower than the frame rate of the input image and controls to reduce the number of frames of the input image to be subject to image processing based on a setting result.

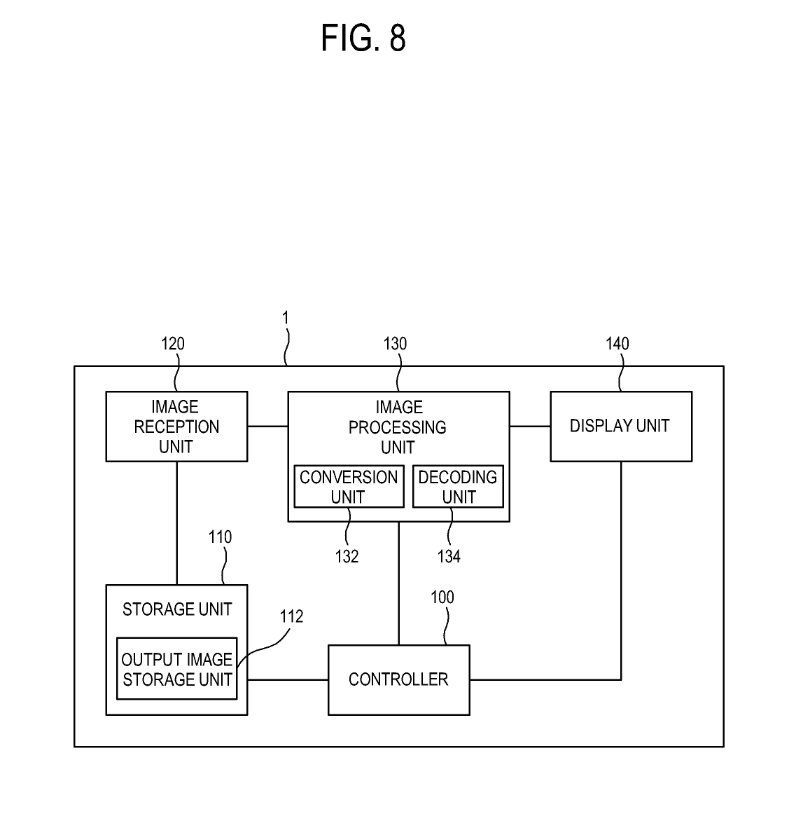

FIG. 8 is a schematic diagram illustrating a configuration of an image processing apparatus 1 according to another exemplary embodiment. The image processing apparatus 1 according to the present exemplary embodiment may further include a conversion unit (e.g., converter) 132 and a decoding unit (e.g., decoder) 134 of an image processing unit (e.g., image processor) 130, an output image storage unit (e.g., output image storage) 112 of a storage unit (e.g., storage) 110, and a user input unit (e.g., user inputter) in addition to the configuration of the image processing apparatus 1 of FIG. 7.

The conversion unit 132 may convert a YCbCr format into an RGB format.

The decoding unit 134, which performs an operation of the image processing unit 130, may perform multiplexing/demultiplexing.

The user input unit may transmit various preset control commands or information to the controller 100 in accordance with user's manipulations and inputs. The user input unit may be provided as a menu key and an input panel installed on an outside of the display apparatus or as a remote controller separate from the display apparatus. Alternatively, the user input unit may be configured as a single body with the display unit (e.g., display) 140. That is, when the display unit 140 is a touch screen, a user may transmit a preset command to the controller 100 by touching an input menu displayed on the display unit 140.

Here, the controller 100 may calculate a real-time reduction rate of frames of an input image based on an image processing speed of the input image and a frame rate of an output image and control the image processing unit 130 to perform down-sampling of the frames of the input image based on the calculated real-time reduction rate.

A common B frame, a lowest-level B frame of a hierarchical B frame, a lowest-level P frame of a hierarchical P frame, and a last P frame within a closed-loop GOP may be selected as discardable frames. The controller 100 may select a frame of an input image for executing reduction of the number of frames to be subject to image processing according to a frame priority and a structure of Group of Pictures (GOP) via down-sampling and discard the selected frame without image processing.

The controller 100 may calculate a frame reduction rate of the output image based on the frame rate of the output image and the frame rate of the input image, control to discard predetermined frames evenly based on the frame reduction rate of the output image when discarding the frames, and control to discard all frames for which reduction in the number of image-processed frames is executed when the number of frames for which reduction in the number of image-processed frames is executed is smaller than the number of predetermined frames of the input image by the frame reduction rate of the output image.

When the number of frames for which reduction of the number of frames subject to image processing is executed is smaller than the number of predetermined frames of the input image by the frame reduction rate of the output image, the controller 100 may calculate the real-time frame reduction rate of the input image based on the image processing speed and the frame rate of the output image, select a frame of the input image for executing frame reduction so as to output an image based on the calculated real-time reduction rate, and image-process the frame without image outputting.

The controller 100 may calculate a ratio between an image processing speed of one frame of an input image in each GOP and an average image processing speed of a frame of an image-processed input image, determine a real-time reduction rate in the GOP by multiplying the calculated ratio by a frame reduction rate of an output image by frame reduction so as to output an image, and evenly execute frame reduction for outputting an image using the real-time reduction rate in the GOP.

When converting an input image from the YCbCr format into the RGB format, the controller 100 may convert the input image including conversion calculation, thereby reducing a calculation amount in conversion.

The controller 100 may control to execute fixed-point processing, removal multiplication, multi-point simultaneous calculation, table querying, removal addition, and amplitude limiting calculation to enable conversion calculation to include shift, table querying, logic operation, and a small quantity of additions.

The controller 100 may reduce resolution of the output image using an every-point calculation based on size of a displaying area of the display unit 140 when an input with respect to firstly fluently playing is made from the user input unit.

The controller 100 may provide the conversion unit 132 and the decoding unit 134 in series to implement parallel operations of conversion from the YCbCr format to the RGB format and image processing of the input image. The controller 100 may reduce the resolution with a proportion of ½ to 1/16.

The controller 100 may compare the resolution of the output image processed by the image processing unit 130 with the size of the displaying area of the display unit 140 and control the image processing unit 130 to display the output image and the input image based on a comparison result or to display an image by scaling the output image.

When the resolution of the output image is smaller than ½ the size of the displaying area of the display unit 140, the controller 100 may enlarge the output image using a bilinear interpolation, maintaining a width to height ratio of the input image. When at least one of a width side and a height side of the output image corresponds to the displaying area of the display unit 140, the controller 100 may control the image processing unit 130 to dispose the other side in a central position of a corresponding side on the displaying area of the display unit 140.

When the resolution of the output image is smaller than a predetermined range of the size of the displaying area of the display unit 140, the controller 100 may control to display at least one of the output image and the input image to be disposed in a central position of the displaying area of the display unit 140.

When the resolution of the output image is larger than a predetermined range of the size of the displaying area of the display unit 140, the controller 100 may narrow the output image using a nearest neighbor method, maintaining the width to height ratio of the input image. When at least one of the width side and the height side of the output image corresponds to the displaying area of the display unit 140, the controller 100 may control to dispose the other side in the central position of the corresponding side on the displaying area of the display unit 140.

The controller 100 may implement fixed-point processing for coordinate calculation so as to optimize the nearest neighbor method and the bilinear interpolation, establish a table for coordinates for conversion when calculating a frame, calculate coordinates of frames by table querying and simple addition operation, without calculation, and control the image processing unit 130 to process RGB colors of a pixel simultaneously by the nearest neighbor method.

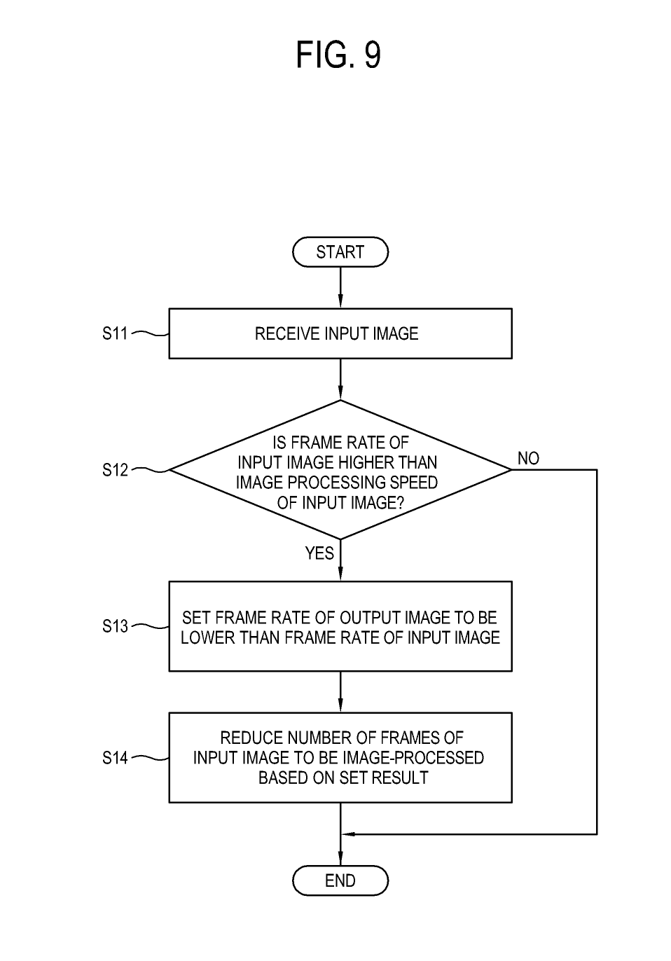

FIG. 9 is a flowchart illustrating an image processing apparatus 1 according to an exemplary embodiment. Operations of the image processing apparatus 1 according to the present exemplary embodiment will be described with reference to FIG. 9.

An input image is received through an image reception unit 120 (operation S11). A storage unit 110 stores information about the input image, that is, a format of a decoding unit 134 of an image processing unit 130, a bit rate, a frame rate of the input image, and a resolution. A controller 100 determines whether the frame rate of the input image is higher than an image processing speed of the input image (operation S12). When the frame rate of the input image is higher than the image processing speed of the input image, a frame rate of an output image is set to be lower than the frame rate of the input image (operation S13). When the image processing speed of the input image is higher than the frame rate of the input image, the image processing unit 130 implements normal image processing. The number of frames of the input image processed is reduced based on the set frame rate of the output image (operation S14).

As described above, in order to optimize an image, a method of reducing frames so as not to output an image, a method of reducing calculation amount by converting an input image from a YCbCr format into an RGB format (resolution reduction, parallel operations of image processing and conversion, and a predetermined calculation method), and a method of scaling an output image may be used alone or in combination with the operations of the image processing apparatus 1 of FIG. 9.

Accordingly, a user may watch seamless images without screen freezing, that is, buffering.

One or more exemplary embodiments may optimally combine video decoding, color change, image scaling, decoding speed control, video frame display, use of a system memory, and frame buffering, thereby obtaining a universal property for improving fluency of video playing. Further, occupancy rates of a Central Processing Unit (CPU) and system resources may be effectively reduced.

The foregoing are only exemplary embodiments, which is not used for limiting the application. Any modifications, equivalent substitutions, and improvements made within the spirit and principle of the present inventive concept, should be covered by protection scope of the application.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units of the above-described apparatuses 1 can include circuitry, a processor, a microprocessor, etc., and may execute a computer program stored in a computer-readable medium.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An image processing apparatus comprising:
an image receiver which receives an input image;
an image processor which processes the received input image to output an output image;
a display which displays the output image;
a storage which stores data and information about the input image; and
a controller which compares an image processing speed of the input image with a frame rate of the input image, sets a frame rate of the output image to be less than the frame rate of the input image when the frame rate of the input image is greater than the image processing speed of the input image, and reduces a number of frames of the input image to be image-processed based on the set frame rate.

2. The image processing apparatus of claim 1, wherein the controller calculates a real-time reduction rate of frames of the input image based on the image processing speed of the input image and the frame rate of the output image and implements down-sampling of the frames of the input image based on the calculated real-time reduction rate.

3. The image processing apparatus of claim 2, wherein the controller selects predetermined frames of the input image for which the reduction of the number of frames to be image-processed is executed according to a frame priority and a structure of Group of Pictures (GOP) via down-sampling and discards the selected predetermined frames without image processing.

4. The image processing apparatus of claim 3, wherein the controller calculates a reduction rate of frames of the output image based on the frame rate of the output image and the frame rate of the input image, discards the predetermined frames evenly based on the calculated reduction rate when discarding the predetermined frames, and discards all frames for which the reduction of the number of frames to be image-processed is executed when the number of frames for which the reduction of the number of frames to be image-processed is executed is less than a number of the predetermined frames of the input image by the calculated reduction rate.

5. The image processing apparatus of claim 3, wherein the controller calculates the real-time reduction rate based on the image processing speed and the frame rate of the output image, selects the predetermined frames of the input image for executing the frame reduction so as to output an image based on the calculated real-time reduction rate, and image-processes the predetermined frames without image outputting when the number of frames for which the reduction of the number of frames to be image-processed is executed is less than a number of the predetermined frames of the input image by the reduction rate of frames of the output image.

6. The image processing apparatus of claim 4, wherein the controller calculates a ratio between an image processing speed of one frame of the input image in each GOP and an average image processing speed of a frame of the input image, determines a real-time reduction rate in the GOP by multiplying the calculated ratio by the reduction rate of frames of the output image by the frame reduction so as to output an image, and evenly executes frame reduction so as to output an image using the determined real-time reduction rate in the GOP.

7. The image processing apparatus of claim 1, wherein the image processor comprises a converter which converts a YCbCr format into an RGB format, and the controller reduces a calculation amount in the conversion by converting the input image including a predetermined conversion calculation when the converter converts the input image from the YCbCr format into the RGB format.

8. The image processing apparatus of claim 7, wherein the controller executes fixed-point processing, removal multiplication, multi-point simultaneous calculation, table querying, removal addition, and amplitude limiting calculation by enabling the predetermined conversion calculation to include shift, table querying, logic operation, and a small quantity of additions.

9. The image processing apparatus of claim 7, further comprising a user inputter which receives an input with respect to an image signal, wherein the controller reduces a resolution of the output image using an every-point calculation based on a size of a displaying area of the display when an input with respect to prioritizing fluid playing is received from the user inputter.

10. The image processing apparatus of claim 7, wherein the image processor further comprises a decoder which decodes the input image, and the converter and the decoder are operation in series to implement parallel operations of the conversion from the YCbCr format to the RGB format and the image processing of the input image.

11. The image processing apparatus of claim 9, wherein the controller reduces the resolution with a proportion of ½ to 1/16.

12. The image processing apparatus of claim 1, wherein the storage comprises an output image storage which stores the output image, and the controller compares a resolution of the output image processed by the image processor with a size of a displaying area of the display and displays the output image and the input image based on a comparison result or displays an image by scaling the output image.

13. The image processing apparatus of claim 12, wherein the controller enlarges the output image using a bilinear interpolation, maintaining a width to height ratio of the input image when the resolution of the output image is smaller than ½ the size of the displaying area of the display, and the controller disposes at least one side of a width side and a height side of the output image in a central position of a corresponding side on the displaying area of the display when the other side corresponds to the displaying area of the display.

14. The image processing apparatus of claim 12, wherein the controller displays at least one of the output image and the input image to be disposed in a central position of the displaying area of the display when the resolution of the output image is less than a predetermined range of the size of the displaying area of the display.

15. The image processing apparatus of claim 12, wherein the controller narrows the output image using a nearest neighbor method, maintaining a width to height ratio of the input image when the resolution of the output image is greater than a predetermined range of the size of the displaying area of the display, and the controller disposes at least one of a width side and a height side of the output image in a central position of the corresponding side on the displaying area of the display when the other side corresponds to the displaying area of the display.

16. The image processing apparatus of claim 13, wherein the controller implements fixed-point processing for coordinate calculation so as to optimize a nearest neighbor method and the bilinear interpolation, establishes a table for coordinates for conversion when calculating a frame, calculates coordinates of frames by table querying and a simple addition operation, without calculation, and processes RGB colors of a pixel simultaneously by the nearest neighbor method.

17. A control method of an image processing apparatus comprising:
comparing an image processing speed of an input image with a frame rate of the input image;
setting a frame rate of an output image to be less than the frame rate of the input image when the frame rate of the input image is greater than the image processing speed of the input image; and
reducing a number of frames of the input image to be image-processed based on the set frame rate.

18. The control method of claim 17, wherein the reducing the number of frames comprises calculating a real-time reduction rate of frames of the input image based on the image processing speed of the input image and the frame rate of the output image and implementing down-sampling of the frames of the input image based on the calculated real-time reduction rate.

19. The control method of claim 18, wherein the implementing the down-sampling comprises selecting predetermined frames of the input image for which the reducing the number of frames to be image-processed is executed according to a frame priority and a structure of Group of Pictures (GOP) via down-sampling and discarding the selected predetermined frames without image processing.

20. The control method of claim 19, wherein the discarding without the image processing comprises calculating a reduction rate of frames of the output image based on the frame rate of the output image and the frame rate of the input image, discarding the predetermined frames evenly based on the calculated reduction rate, and discarding all frames for which the reducing the number of frames to be image-processed is executed when the number of frames for which the reducing the number of frames to be image-processed is executed is less than a number of the predetermined frames of the input image by the calculated reduction rate.

21. The control method of claim 19, wherein the discarding without the image processing comprises calculating the real-time reduction rate based on the image processing speed and the frame rate of the output image, selecting the predetermined frames of the input image for executing the frame reduction so as to output an image based on the calculated real-time reduction rate, and image-processing the predetermined frames without image outputting when the number of frames for which the reducing the number of frames to be image-processed is executed is less than a number of the predetermined frames of the input image by the reduction rate of frames of the output image.

22. The control method of claim 20, wherein the discarding all the frames comprises calculating a ratio between an image processing speed of one frame of the input image in each GOP and an average image processing speed of a frame of the input image, determining a real-time reduction rate in the GOP by multiplying the calculated ratio by the reduction rate of frames of the output image by the frame reduction so as to output an image, and evenly executing frame reduction so as to output an image using the determined real-time reduction rate in the GOP.

23. The control method of claim 17, wherein the reducing the number of frames comprises reducing a calculation amount in conversion by converting the input image including a predetermined conversion calculation when converting the input image from a YCbCr format into an RGB format.

24. The control method of claim 23, wherein the predetermined conversion calculation is enabled to include shift, table querying, logic operation, and a small quantity of additions to execute fixed-point processing, removal multiplication, multi-point simultaneous calculation, table querying, removal addition, and amplitude limiting calculation.

25. The control method of claim 23, wherein the reducing the calculation amount comprises reducing a resolution of the output image using an every-point calculation based on a size of a displaying area in which an image is displayed when an input with respect to prioritizing fluid playing is received from a user.

26. The control method of claim 23, wherein the reducing the calculation amount comprises implementing parallel operations of the conversion from the YCbCr format to the RGB format and the image processing of the input image by disposing a converter converting the YCbCr format to the RGB format and a decoder image-processing the input image in series.

27. The control method of claim 25, wherein the reducing the resolution comprises reducing the resolution with a proportion of ½ to 1/16.

28. The control method of claim 17, wherein the reducing the number of frames comprises comparing a resolution of the output image with a size of a displaying area on which the output image is displayed and displaying the output image and the input image based on a comparison result or displaying an image by scaling the output image.

29. The control method of claim 28, wherein the displaying the image comprises enlarging the output image using a bilinear interpolation, maintaining a width to height ratio of the input image when the resolution of the output image is smaller than ½ the size of the displaying area on which the output image is displayed, and disposing at least one side of a width side and a height side of the output image in a central position of a corresponding side on the displaying area on which the output image is displayed when the other side corresponds to the displaying area on which the output image is displayed.

30. The control method of claim 28, wherein the displaying the image comprises displaying at least one of the output image and the input image to be disposed in a central position of the displaying area on which the output image is displayed when the resolution of the output image is less than a predetermined range of the size of the displaying area on which the output image is displayed.

31. The control method of claim 28, wherein the displaying the image comprises narrowing the output image using a nearest neighbor method, maintaining a width to height ratio of the input image when the resolution of the output image is greater than a predetermined range of the size of the displaying area on which the output image is displayed, and disposing at least one of a width side and a height side of the output image in a central position of the corresponding side on the displaying area on which the output image is displayed when the other side corresponds to the displaying area on which the output image is displayed.

32. The control method of claim 29, further comprising implementing fixed-point processing for coordinate calculation so as to optimize a nearest neighbor method and the bilinear interpolation, establishing a table for coordinates for conversion when calculating a frame, calculating coordinates of frames by table querying and a simple addition operation, without calculation, and processing RGB colors of a pixel simultaneously by the nearest neighbor method.

33. The image processing apparatus of claim 15, wherein the controller implements fixed-point processing for coordinate calculation so as to optimize the nearest neighbor method and the bilinear interpolation, establishes a table for coordinates for conversion when calculating a frame, calculates coordinates of frames by table querying and a simple addition operation, without calculation, and processes RGB colors of a pixel simultaneously by the nearest neighbor method.

34. The control method of claim 31, further comprising implementing fixed-point processing for coordinate calculation so as to optimize the nearest neighbor method and the bilinear interpolation, establishing a table for coordinates for conversion when calculating a frame, calculating coordinates of frames by table querying and a simple addition operation, without calculation, and processing RGB colors of a pixel simultaneously by the nearest neighbor method.

35. An image processing apparatus comprising:
an image processor which processes an input image to output an output image; and
a controller which compares an image processing speed of the input image with a frame rate of the input image, sets a frame rate of the output image to be less than the frame rate of the input image when the frame rate of the input image is greater than the image processing speed of the input image, and reduces a number of frames of the input image to be image-processed based on the set frame rate.

36. The image processing apparatus of claim 35, wherein the controller calculates a real-time reduction rate of frames of the input image based on the image processing speed of the input image and the frame rate of the output image and implements down-sampling of the frames of the input image based on the calculated real-time reduction rate.

37. The image processing apparatus of claim 36, wherein the controller selects predetermined frames of the input image for which the reduction of the number of frames to be image-processed is executed according to a frame priority and a structure of Group of Pictures (GOP) via down-sampling and discards the selected predetermined frames without image processing.

38. The image processing apparatus of claim 35, wherein the image processor comprises a converter which converts a YCbCr format into an RGB format, and the controller reduces a calculation amount in the conversion by converting the input image including a predetermined conversion calculation when the converter converts the input image from the YCbCr format into the RGB format.

39. The image processing apparatus of claim 35, further comprising:
a storage which stores data and information about the input image,
wherein the storage comprises an output image storage which stores the output image, and the controller compares a resolution of the output image processed by the image processor with a size of a displaying area of a display and displays the output image and the input image based on a comparison result or displays an image by scaling the output image.

40. A computer readable recording medium having recorded thereon a program executable by a computer for performing the method of claim 17.
